(19) United States
(12) Patent Application Publication
(10) Pub. No.: US 2026/0149131 A1
(43) Pub. Date: May 28, 2026

(54) ELECTRODE ASSEMBLY, METHOD FOR MANUFACTURING ELECTRODE ASSEMBLY, AND SECONDARY BATTERY INCLUDING ELECTRODE ASSEMBLY

(71) Applicant: SAMSUNG SDI CO., LTD., Yongin-si (KR)

(72) Inventors: Jungyeon OH, Yongin-si (KR); Meenkyoung JUNG, Yongin-si (KR); Jae Gyun DOO, Yongin-si (KR); Hyo-Rim BAK, Yongin-si (KR); Seung-Young PARK, Yongin-si (KR)

(21) Appl. No.: 19/369,519

(22) Filed: Oct. 27, 2025

(30) Foreign Application Priority Data
Nov. 22, 2024 (KR) 10-2024-0168002

(51) Int. Cl. H01M 50/533; H01M 10/04

(52) U.S. Cl. CPC H01M 50/533; H01M 10/0431

(57) ABSTRACT

An electrode assembly includes: a first electrode; a second electrode; a separator that is disposed between the first electrode and the second electrode; a first electrode tab that is disposed on the first electrode; and a second electrode tab that is disposed on the second electrode. A first inclined portion formed at one end of the first electrode tab and a lower surface of the first electrode tab form an obtuse angle.

### CROSS-REFERENCE TO RELATED APPLICATION

The present application claims priority to and the benefit under 35 U.S. C § 119(a)-(d) of Korean Application No. 10-2024-0168002, filed in the Korean Intellectual Property Office on Nov. 22, 2024, the entire disclosure of which is incorporated herein by reference.

### BACKGROUND

### Field

The present disclosure relates to an electrode assembly, a method for manufacturing the electrode assembly, and a secondary battery including the electrode assembly.

### Description of the Related Art

While primary batteries are not designed to be (re)charged, secondary (also known as rechargeable) batteries are designed to be discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly.

In secondary batteries, especially lithium ion batteries, charging and discharging processes are driven by the migration of lithium ions between the electrolyte and the electrode. During such processes, the electrode, containing the active material, undergoes a physical volume change as the electrode absorbs or releases the lithium ions. Such a physical volume change may result in issues that may significantly affect the life and performance of the battery.

For example, a physical volume change of the electrode assembly may result in electrodes subject to mechanical stress due to steps or burrs formed by the edge region of the electrode tab or the like, while the electrode assembly is being wound to be inserted in the case of the secondary battery. As mechanical stress accumulates, cracks may develop in or on the electrodes on which the electrode tabs are positioned. In the long term, these cracks may cause short circuits or separation between layers in the electrode assembly, leading to performance degradation, increased electrical resistance, or lifespan reduction of the battery, causing safety and reliability issues of the battery.

The information disclosed in this Background section is for enhancement of understanding of the background of the present disclosure. The section may contain information that does not constitute related (or prior) art.

### SUMMARY

Aspects of embodiments of the present disclosure provide an electrode assembly, a method for manufacturing the same, and a secondary battery including the same to solve the above problems.

According to some embodiments of the present disclosure, the electrode assembly may include a first electrode, a second electrode, a separator disposed between the first electrode and the second electrode, a first electrode tab disposed on the first electrode, and a second electrode tab disposed on the second electrode. The first electrode tab may include a first inclined portion formed at an end of the first electrode tab. In addition, the first inclined portion and a lower surface of the first electrode tab may form an obtuse angle.

Embodiments of the disclosure provide an electrode assembly, including: a first electrode; a second electrode; a separator disposed between the first electrode and the second electrode; a first electrode tab disposed on the first electrode; and a second electrode tab disposed on the second electrode, wherein a first inclined portion formed at an end of the first electrode tab and a lower surface of the first electrode tab form an obtuse angle.

According to some embodiments of the present disclosure, the first inclined portion may have a thickness that is thinner at a position closer to the end of the first electrode tab.

In some embodiments, the first inclined portion has a thickness gradually decreasing towards the end of the first electrode tab.

According to some embodiments of the present disclosure, the first inclined portion may have an angle of 100 to 150 degrees with respect to the lower surface of the first electrode tab.

In some embodiments, the obtuse angle ranges from 100 to 150 degrees.

According to some embodiments of the present disclosure, an end portion of the first inclined portion may be separated from the first electrode.

According to some embodiments of the present disclosure, a length direction of the first electrode tab may be a first direction. In addition, an end portion of the first inclined portion may protrude in the first direction by a maximum of 120 um, relative to an end of the lower surface of the first electrode tab connected to the first inclined portion.

In some embodiments, an end portion of the first inclined portion protrudes in a longitudinal direction equal to or less than 120 μm relative to an end of the lower surface of the first electrode tab.

According to some embodiments of the present disclosure, the first inclined portion may have the same height as the first electrode tab in a second direction perpendicular to the first direction.

In some embodiments, the first inclined portion has a height substantially identical to the first electrode tab in a direction perpendicular to the longitudinal direction.

According to some embodiments of the present disclosure, the first electrode tab may include a second inclined portion that is formed to be symmetric to the first inclined portion at the end of the first electrode tab, and an end portion of the first inclined portion may be connected to an end portion of the second inclined portion.

In some embodiments, a second inclined portion is formed at the end of the first electrode tab, and wherein an end portion of the first inclined portion and an end portion of the second inclined portion form an interface.

According to some embodiments of the present disclosure, a length direction of the first electrode tab may be a first direction. In addition, the second inclined portion may be symmetric to the first inclined portion on the basis of a central axis of the first electrode tab in the first direction.

In some embodiments, the second inclined portion is symmetric to the first inclined portion relative to a central axis of the first electrode tab in a longitudinal direction.

According to some embodiments of the present disclosure, the first inclined portion may be formed to be connected to an end of the lower surface of the first electrode tab. In addition, the second inclined portion may be formed to be connected to an end of an upper surface of the first electrode tab.

In some embodiments, the first inclined portion corresponds to the lower surface of the first electrode tab, and wherein the second inclined portion corresponds to an upper surface of the first electrode tab.

According to some embodiments of the present disclosure, the first inclined portion may have an angle of 100 to 150 degrees with respect to the lower surface of the first electrode tab, and the second inclined portion may have an angle of 100 to 150 degrees with respect to the upper surface of the first electrode tab.

In some embodiments, the first inclined portion has an angle ranging from 100 to 150 degrees relative to the lower surface of the first electrode tab, and wherein the second inclined portion has an angle ranging from 100 to 150 degrees relative to the upper surface of the first electrode tab.

According to some embodiments of the present disclosure, a length direction of the first electrode tab may be a first direction. In addition, the end portions of the first inclined portion and the second inclined portion may protrude in the first direction relative to the lower surface and an upper surface of the first electrode tab.

In some embodiments, the end portion of the first inclined portion and the end portion of the second inclined portion protrude in a longitudinal direction relative to either an end of the lower surface of the first electrode tab or an end of an upper surface of the first electrode tab.

According to some embodiments of the present disclosure, a height of the first inclined portion in a second direction perpendicular to the first direction may be equal to a height of the second inclined portion in the second direction.

In some embodiments, a height of the first inclined portion in a direction perpendicular to the longitudinal direction is substantially equal to a height of the second inclined portion in the direction perpendicular to the longitudinal direction.

According to some embodiments of the present disclosure, the first electrode tab may include a slitting portion that is positioned between the first inclined portion and the second inclined portion to connect the first inclined portion and the second inclined portion.

In some embodiments, a slitting portion is formed at the end of the first electrode tab and is positioned between the first inclined portion and the second inclined portion such that an end portion of the first inclined portion and the slitting portion form a first interface and an end portion of the second inclined portion and the slitting portion form a second interface.

According to some embodiments of the present disclosure, the slitting portion may be rounded.

In some embodiments, the slitting portion has a non-flat surface.

According to some embodiments of the present disclosure, a secondary battery may include the electrode assembly described above.

Embodiments of the disclosure provide a secondary battery including an electrode assembly including: a first electrode; a second electrode; a separator disposed between the first electrode and the second electrode; a first electrode tab disposed on the first electrode; and a second electrode tab disposed on the second electrode, wherein a first inclined portion formed at an end of the first electrode tab and a lower surface of the first electrode tab form an obtuse angle.

According to some embodiments of the present disclosure, a method for manufacturing an electrode assembly may include: forming a first inclined portion at an end portion of a first electrode tab by chamfering the end portion of the first electrode tab; disposing the first electrode tab on a first electrode and disposing a second electrode tab on a second electrode; and sequentially stacking the first electrode tab, the first electrode, a separator, the second electrode, and the second electrode tab.

Embodiments of the disclosure provide a method for manufacturing an electrode assembly, including: forming a first inclined portion at an end portion of a first electrode tab by chamfering the end portion of the first electrode tab; disposing the first electrode tab on a first electrode of the electrode assembly and a second electrode tab on a second electrode of the electrode assembly; and stacking the first electrode tab, the first electrode, a separator, the second electrode, and the second electrode tab.

According to some embodiments of the present disclosure, the first inclined portion may have a thickness that is thinner at a position closer to the end of the first electrode tab, and the first inclined portion may have an angle of 100 to 150 degrees with respect to a lower surface of the first electrode tab.

In some embodiments, the first inclined portion has a thickness gradually decreasing towards the end of the first electrode tab, and wherein the first inclined portion and a lower surface of the surface of the first electrode tab has an angle ranging from 100 to 150 degrees.

According to some embodiments of the present disclosure, the forming of the first inclined portion may include forming a second inclined portion to be symmetric to the first inclined portion by chamfering an end portion of the first electrode tab.

In some embodiments, the forming includes forming a second inclined portion at the end portion of the first electrode tab, symmetric to the first inclined portion, by chamfering the end portion of the first electrode tab.

According to some embodiments of the present disclosure, the forming the first inclined portion may include forming a slitting portion that connects the first inclined portion and the second inclined portion.

In some embodiments, the forming further includes forming a slitting portion at the end portion of the first electrode tab and positioned between the first inclined portion and the second inclined portion.

According to some embodiments of the present disclosure, the disposing of the first electrode tab on the first electrode and the disposing of the second electrode tab on the second electrode may include combining the first electrode tab with the first electrode by pressing the first electrode tab under a predetermined temperature condition.

In some embodiments, the disposing comprises combining the first electrode tab with the first electrode.

According to various embodiments of the present disclosure, the first electrode tab may include the first inclined portion at the end of the first electrode tab, the first inclined portion and the lower surface of the first electrode tab may form the obtuse angle, and the end portion of the first inclined portion may be separated from the first electrode. With such a configuration, the mechanical stress generated by the end portion of the first electrode tab pressing the electrode substrate can be reduced. As a result, cracks can be prevented from occurring in the electrode assembly.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 shows an electrode assembly according to an embodiment of the present disclosure.

FIG. 2 is a plan view showing a first electrode and a first electrode tab according to an embodiment of the present disclosure.

FIG. 3 is a perspective view showing a first electrode tab according to an embodiment of the present disclosure.

FIG. 4 shows a shape of a first electrode tab according to an embodiment of the present disclosure.

FIG. 5 is a perspective view showing a first electrode tab according to an embodiment of the present disclosure.

FIG. 6 shows a shape of a first electrode tab according to an embodiment of the present disclosure.

FIG. 7 is a perspective view showing a first electrode tab according to an embodiment of the present disclosure.

FIG. 8 shows a shape of a first electrode tab according to an embodiment of the present disclosure.

FIG. 9 is a flow chart showing a method for manufacturing an electrode assembly according to an embodiment of the present disclosure.

FIG. 10 shows a secondary battery including an electrode assembly according to an embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her disclosure in the best way. Therefore, the embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

Also, it will be further understood that the terms “includes,” “including,” “comprises, ” and/or “comprising, ” when used in this specification, specify the presence of stated features, integers, steps, operations, elements, and/or components but do not preclude the presence or addition of one or more other features, integers, steps, operations, elements, components, and/or groups thereof.

The embodiments described herein can be explained with reference to cross-sectional views and/or plain views as example views of the present disclosure. In the drawing, the thicknesses of films and regions can be exaggerated for effective description of technical contents. Thus, regions presented as an example in the drawings have general properties, and shapes of the exemplified areas can be used to illustrate a specific shape of a device region. Therefore, this should not be construed as limited to the scope of the present disclosure. Although the terms such as first, second, and third are used to describe various components in various embodiments herein, the components should not be limited to these terms. These terms are used only to distinguish one component from another component. Embodiments described and exemplified herein include complementary embodiments thereof. Like reference numerals refer to like elements throughout the specification.

As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. §132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Disposing an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled, ” “linked” or “connected” to each other, or another component may be “interposed” between the components”. It will also be understood that when an element is referred to as being “electrically coupled” to another element, it may be directly coupled to the other element or intervening elements may be present.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to be limiting of the present disclosure.

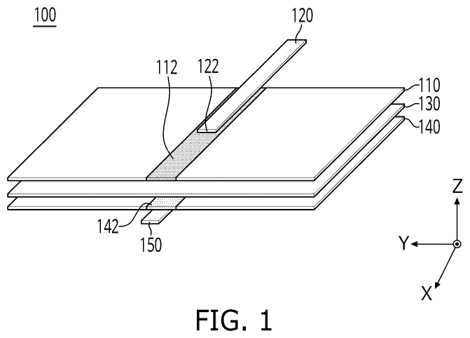

FIG. 1 shows an electrode assembly 100 according to an embodiment of the present disclosure.

An electrode assembly 100 may include a first electrode 110, a first electrode tab 120 disposed on the first electrode 110, a separator 130, a second electrode 140, and a second electrode tab 150 disposed on the second electrode 140. The electrode assembly 100 may be mounted on a battery while being stacked thereon or may be mounted on a battery while being wound relative to a winding axis.

The first electrode 110 of the battery may correspond to a positive electrode or a negative electrode in the battery. In some embodiments, the second electrode 140 of the battery may be a negative or a positive electrode opposite to the positive electrode or the negative electrode of the first electrode 110 of the battery. In some embodiments, the first electrode 110 of the battery is a positive electrode, and the second electrode 140 of the battery is a negative electrode. In some embodiments, the first electrode 110 of the battery is a negative electrode, and the second electrode 140 of the battery is a positive electrode. In some embodiments, a substrate of the negative electrode may include copper (Cu), and a substrate of the positive electrode may include aluminum (Al). However, the present disclosure is not limited thereto, and various substrates known in the art may be used.

In some embodiments, the first electrode 110 is a negative electrode, and the first electrode 110 may be formed by coating a first electrode substrate, including a metal foil, such as copper, a copper alloy, nickel, or a nickel alloy, with a first electrode active material, including graphite or carbon. The first electrode 110 may include a first uncoated portion 112 corresponding to a region where the first electrode substrate is not coated with the first electrode active material. The first electrode tab 120 may be disposed on the first uncoated portion 112. The first electrode tab 120 may be configured as a passage for current flow between the first electrode 110 and the negative current collector.

In some embodiments, the first electrode tab 120 may include one end and the other end opposite to the one end. The other end may protrude from one side of the first electrode 110 or one side of the separator 130.

In some embodiments, the second electrode 140 is a positive electrode, and the second electrode 140 may be formed by coating a second electrode substrate, including a metal foil such as aluminum or an aluminum alloy, with a second electrode active material, including a transition metal oxide. The second electrode 140 may include a second uncoated portion 142 corresponding to a region where the second electrode substrate is not coated with the second electrode active material. The second electrode tab 150 may be disposed on the second uncoated portion 142. The second electrode tab 150 may be configured as a passage for current flow between the second electrode 140 and the positive electrode current collector.

In some embodiments, the second electrode tab 150 may include an inner end portion positioned to face the first electrode tab 120 while the first electrode 110, the separator 130, and the second electrode 140 are interposed therebetween. The second electrode tab 150 may further include an outer end portion protruding outward from the second electrode 140. The outer end portion of the second electrode tab 150 may protrude further than one side of the second electrode 140 or one side of the separator 130.

The first uncoated portion 112, on which the first electrode tab 120 is positioned, is positioned substantially at the middle of the first electrode 110 in the longitudinal direction, and the second uncoated portion 142, on which the second electrode tab 150 is positioned, is positioned substantially at the middle of the second electrode 140 in the longitudinal direction. However, the present disclosure is not limited thereto. In some embodiments, the first uncoated portion 112 and the first electrode tab 120 positioned on the first uncoated portion 112 may be positioned at one end of the first electrode 110 in the longitudinal direction. Similarly, the second uncoated portion 142 and the second electrode tab 150 positioned on the second uncoated portion 142 may be positioned at one end of the second electrode 140 in the longitudinal direction. In this manner, the first uncoated portion 112 and the second uncoated portion 142 may be positioned at the same location in the same direction on the first electrode 110 and the second electrode 140, respectively.

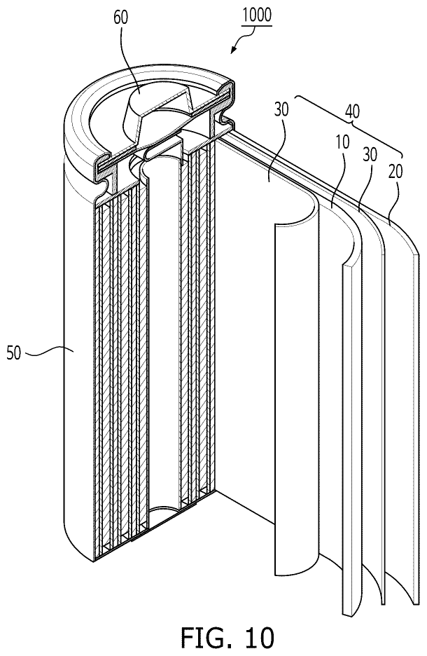

A plurality of electrodes, separators, and electrode tabs of the electrode assembly 100 may be stacked and/or wound. Then, the first electrode tab 120 may be positioned at an upper portion (see FIG. 10) of the electrode assembly 100, and the second electrode tab 150 may be positioned at a lower portion (see FIG. 10) of the electrode assembly 100, or may be positioned on one side in the same direction. In some embodiments, the positions of the upper portion and lower portion may change relative to how the secondary battery is positioned, such as being rotated left and right or up and down.

The first electrode tab 120 may include a first inclined portion 122 at one end thereof. The first inclined portion 122 may form an obtuse angle relative to a lower surface of the first electrode tab 120.

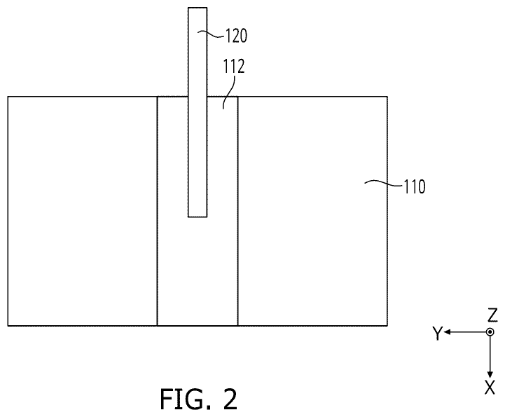

FIG. 2 is a plan view showing a first electrode 110 and a first electrode tab 120 according to an embodiment of the present disclosure.

Referring to FIG. 2, the first electrode tab 120 may be disposed on the first electrode 110. According to an embodiment, the first electrode tab 120 may be disposed on the first uncoated portion 112 of the first electrode 110. The first uncoated portion 112 may be positioned in the middle region of the first electrode 110 in the longitudinal direction (for example, Y-axis direction) or at one end thereof.

The longitudinal direction (for example, X-axis direction) of the first electrode tab 120 may be perpendicular to the longitudinal direction of the first electrode 110. The longitudinal direction (for example, X-axis direction) of the first uncoated portion 112 may be perpendicular to the longitudinal direction of the first electrode 110. Assuming that the longitudinal direction of the first electrode tab 120 is a first direction (for example, X-axis direction), the first electrode tab 120 may have a thickness in a second direction (for example, Z-axis direction) that is perpendicular to the first direction. The second direction of the first electrode tab 120 may be perpendicular to the upper surface of the first electrode 110 and the upper surface of the first uncoated portion 112 on which the first electrode tab 120 is formed. According to an embodiment, the first electrode tab 120 may be formed to protrude from one side of the first electrode 110 and the first uncoated portion 112 in the first direction.

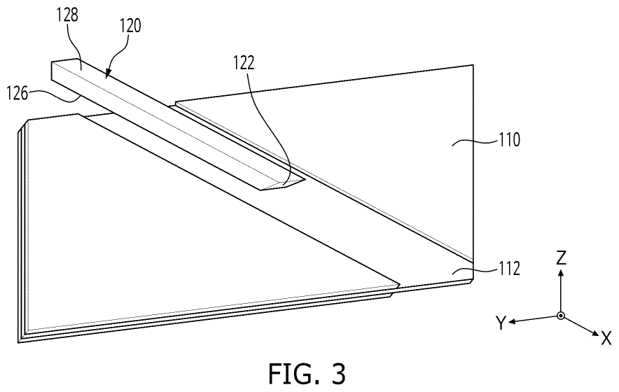

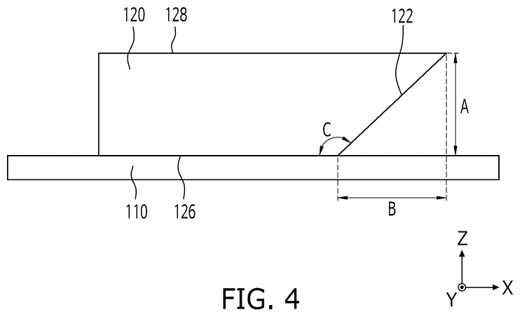

FIG. 3 is a perspective view showing a first electrode tab 120 according to an embodiment of the present disclosure. FIG. 4 shows a shape of a first electrode tab 120 according to an embodiment of the present disclosure.

Referring to FIG. 3, the first electrode tab 120 may include the first inclined portion 122 at one end of the first electrode tab 120. The first inclined portion 122 may have a thickness gradually decreasing towards the one end of the first electrode tab 120. The first inclined portion 122 may have a distance from a lower surface 126 of the first electrode tab 120 in the second direction gradually increasing towards the one end of the first electrode tab 120. In some embodiments, the first electrode tab 120 may have a shape where an upper surface 128 protrudes from the lower surface 126 of the first electrode tab 120 in the first direction.

An end portion of the first inclined portion 122 may be separated from the first electrode 110. According to an embodiment, the end portion of the first inclined portion 122 may be separated from the first uncoated portion 112 in the second direction. An edge region of the first electrode tab 120, particularly, a sharp edge region such as the end portion of the first inclined portion 122, may come into contact with the first electrode 110. The electrode assembly may repeatedly expand and contract in accordance with charge and discharge, causing a crack to form and grow. In this manner, according to an embodiment, the end portion of the first inclined portion 122 of the first electrode tab 120 may be formed to be separated from the first electrode 110. Advantageously, mechanical stress can be reduced, avoiding the sharp edge region of the first electrode tab 120 coming into contact with the first electrode 110. As a result, cracks in the electrode assembly can be prevented from occurring.

Referring to FIG. 4, the first inclined portion 122 may extend from one end of the lower surface 126 of the first electrode tab 120 to one end of the upper surface 128 of the first electrode tab 120. The lower surface 126 of the first electrode tab 120 and the first inclined portion 122 may form a predetermined angle C. According to an embodiment, the first inclined portion 122 may form an obtuse angle relative to the lower surface 126 of the first electrode tab 120. In some embodiments, the first inclined portion 122 may have an angle of 100 to 150 degrees relative to the lower surface 126 of the first electrode tab 120. According to an embodiment, the first inclined portion 122 may form an angle of 135 degrees relative to the lower surface 126 of the first electrode tab 120. In some embodiments, the first inclined portion 122 may form an acute angle relative to the upper surface of the first electrode 110. In some embodiments, the first inclined portion 122 may have an angle of 30 to 80 degrees relative to the upper surface of the first electrode 110.

The first inclined portion 122 may have a horizontal length B and a vertical length A. The horizontal length B of the first inclined portion 122 may correspond to a difference in length between the upper surface 128 of the first electrode tab 120 and the lower surface 126 of the first electrode tab 120 in the first direction. According to an embodiment, the end portion of the first inclined portion 122 may protrude up to 120 μm in the first direction relative to one end of the lower surface 126 of the first electrode tab 120 connected to the first inclined portion 122. In some embodiments, the horizontal length B may be about 120 μm.

The vertical length A of the first inclined portion 122 may correspond to the maximum distance the first inclined surface is separated from the first electrode 110. The first inclined portion 122 may be connected to the upper surface 128 of the first electrode tab 120. The upper surface 128 of the first electrode tab 120 and the first inclined portion 122 may form a predetermined angle. According to an embodiment, the first inclined portion 122 may form an acute angle with the upper surface 128 of the first electrode tab 120. In some embodiments, the first inclined portion 122 may have a length equal to a thickness of the first electrode tab 120 in the second direction perpendicular to the first direction.

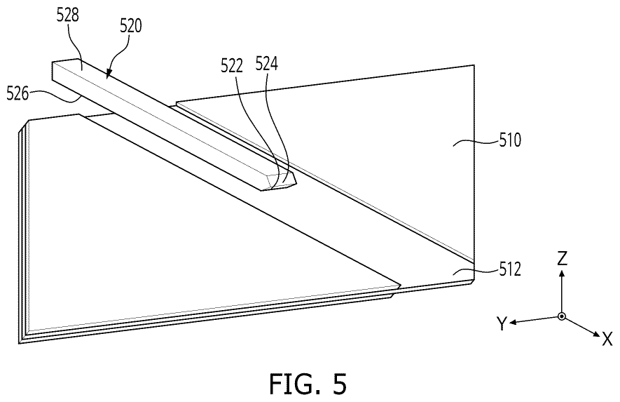

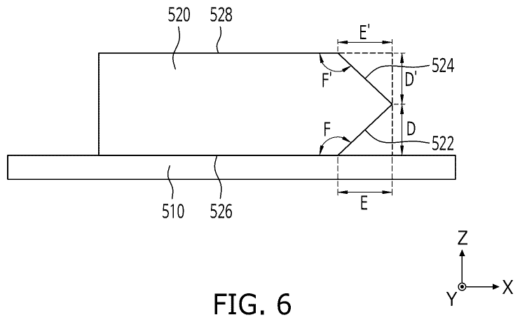

FIG. 5 is a perspective view showing a first electrode tab 520 according to an embodiment of the present disclosure. FIG. 6 shows a shape of a first electrode tab 520 according to an embodiment of the present disclosure.

Referring to FIG. 5, the first electrode tab 520 may include a first inclined portion 522 and a second inclined portion 524 at one end of the first electrode tab 520. The first electrode tab 520 may have a thickness gradually decreasing towards the one end of the first electrode tab 520. In some embodiments, the first inclined portion 522 may have a distance from a lower surface 526 of the first electrode tab 520 in the second direction gradually increasing towards the one end of the first electrode tab 520. The second inclined portion 524 may have a distance from an upper surface 528 of the first electrode tab 520 in the second direction gradually increasing towards the one end of the first electrode tab 520.

An end portion of the first inclined portion 522 may be separated from the first electrode 510. According to an embodiment, the end portion of the first inclined portion 522 may be separated from the first uncoated portion 512 in the second direction. An end portion of the second inclined portion 524 may be separated from the first electrode 510. According to an embodiment, the end portion of the second inclined portion 524 may be separated from the first uncoated portion 512 in the second direction.

According to an embodiment, the end portion of the first inclined portion 522 may be connected to the end portion of the second inclined portion 524. The end portion of the first inclined portion 522 and the end portion of the second inclined portion 524 may be the same. In some embodiments, the end portion of the first inclined portion 522 and the end portion of the second inclined portion 524 may form a straight line.

An end portion of the first electrode tab 520 (for example, the end portions of the first inclined portion 522 and the second inclined portion 524) may come into contact with the first electrode 510. The electrode assembly may repeatedly expand and contract in accordance with charge and discharge, causing a crack to form and grow. In this manner, according to an embodiment, the end portions of the first inclined portion 522 and the second inclined portion 524 of the first electrode tab 120 may be formed to be separated from the first electrode 110. Advantageously, mechanical stress can be reduced, avoiding the end portion of the first electrode tab 120 coming into contact with the first electrode 110. As a result, cracks in the electrode assembly can be prevented from occurring.

Referring to FIG. 6, the first inclined portion 522 may extend from one end of the lower surface 526 of the first electrode tab 520. The second inclined portion 524 may extend from one end of the upper surface 528 of the first electrode tab 520.

The lower surface 526 of the first electrode tab 520 and the first inclined portion 522 may form a predetermined angle F. According to an embodiment, the first inclined portion 522 may form an obtuse angle relative to the lower surface 526 of the first electrode tab 520. In some embodiments, the first inclined portion 522 may have an angle of 100 to 150 degrees relative to the lower surface 526 of the first electrode tab 520. According to an embodiment, the first inclined portion 522 may form an angle of 135 degrees relative to the lower surface 526 of the first electrode tab 520.

The upper surface 528 of the first electrode tab 520 and the second inclined portion 524 may form a predetermined angle F′. According to an embodiment, the second inclined portion 524 may form an obtuse angle relative to the upper surface 528 of the first electrode tab. In some embodiments, the second inclined portion 524 may have an angle of 100 to 150 degrees relative to the upper surface 528 of the first electrode tab 520. According to an embodiment, the second inclined portion 524 may form an angle of 135 degrees relative to the upper surface 528 of the first electrode tab 520.

The first inclined portion 522 and the second inclined portion 524 may be symmetrically formed. In some embodiments, a longitudinal direction of the first electrode tab 520 may be the first direction, and the second inclined portion 524 may be symmetric to the first inclined portion 522 with respect to a central axis of the first electrode tab 520 in the first direction. According to an embodiment, an angle F′ formed by the second inclined portion 524 and the upper surface 528 of the first electrode tab 520 may be equal to an angle F formed by the first inclined portion 522 and the lower surface 526 of the first electrode tab 520. In some embodiments, the first inclined portion 522 and the second inclined portion 524 may be asymmetrically formed, and the present disclosure is not limited thereto.

The first inclined portion 522 and the second inclined portion 524 may each have a horizontal length E and E′, respectively, and a vertical length D and D′, respectively. The horizontal length E of the first inclined portion 522 and the horizontal length E′ of the second inclined portion 524 may correspond to the maximum lengths by which the end portions of the first electrode tab 520 protrude in the first direction. In some embodiments, the end portions of the first inclined portion 522 and the second inclined portion 524 may protrude in the first direction by the maximum lengths relative to the lower surface 526 and/or the upper surface 528 of the first electrode tab 520. According to an embodiment, the horizontal length E of the first inclined portion 522 may be equal to the horizontal length E′ of the second inclined portion 524. The horizontal length E of the first inclined portion 522 and the horizontal length E′ of the second inclined portion 524 may be adjusted in accordance with the angle at which the first electrode tab 520 is cut. However, the present disclosure is not limited to a specific forming method.

A sum of the vertical length D of the first inclined portion 522 and the vertical length D′ of the second inclined portion 524 may be equal to a length of the first electrode tab 520 in the second direction, that is, a thickness of the first electrode tab 520. The vertical length D of the first inclined portion 522 may be the maximum distance by which the first inclined portion 522 is separated from the first electrode 510. The vertical length D′ of the second inclined portion 524 may be the maximum distance by which the second inclined portion 524 is separated from the first electrode 510. According to an embodiment, a length of the first inclined portion 522 in the second direction perpendicular to the first direction may be equal to a length of the second inclined portion 524 in the second direction. In some embodiments, the vertical lengths D of the first inclined portion 522 and D′ of the second inclined portion 524 may be equal to 60 μm.

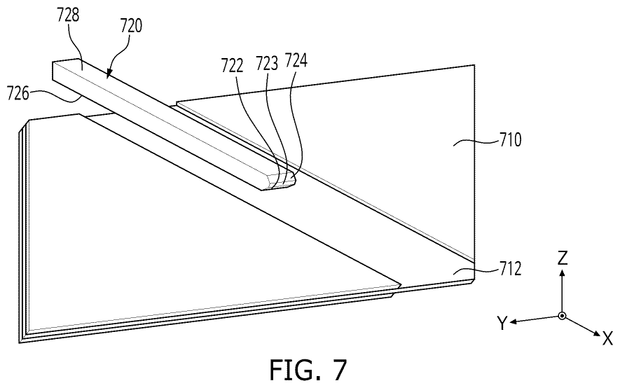

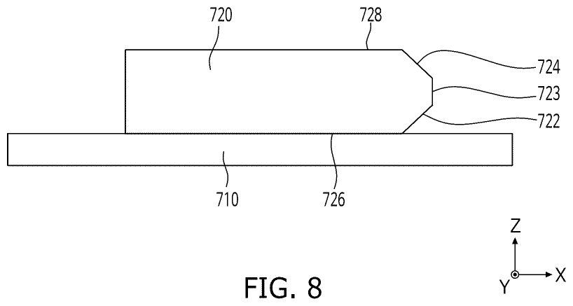

FIG. 7 is a perspective view showing a first electrode tab 720 according to an embodiment of the present disclosure. FIG. 8 shows a shape of a first electrode tab 720 according to an embodiment of the present disclosure.

Referring to FIG. 7, the first electrode tab 720 may further include a slitting portion 723 at one end of the first electrode tab 720. The slitting portion 723 may be positioned between the first inclined portion 722 and the second inclined portion 724 in the first electrode tab 720. According to an embodiment, the slitting portion 723 may connect the first inclined portion 722 and the second inclined portion 724.

The first electrode tab 720 may have a thickness gradually decreasing towards the one end of the first electrode tab 720. In some embodiments, the first inclined portion 722 may have a distance from a lower surface 726 of the first electrode tab 720 in the second direction gradually increasing towards the one end of the first electrode tab 720. The second inclined portion 724 may have a distance from an upper surface 728 of the first electrode tab 720 in the second direction gradually increasing towards the one end of the first electrode tab 720. In some embodiments, a thickness of the first electrode tab 720 between the first inclined portion 722 and the second inclined portion 724 may be less at a position closer to one end of the first electrode tab 720. In some embodiments, a length (that is, thickness) of the slitting portion 723 in the second direction may correspond to the minimum thickness of the first electrode tab 720.

An end portion of the first inclined portion 722 may be separated from the first electrode 710. According to an embodiment, the end portion of the first inclined portion 722 may be separated from the first uncoated portion 712 in the second direction. The end portion of the first electrode tab 720 may come into contact with the first electrode 710. The electrode assembly may repeatedly expand and contract in accordance with charge and discharge, causing a crack to form and grow. In this manner, according to an embodiment, the end portion of the first electrode tab 720, that is, the slitting portion 723, may be formed to be separated from the first electrode 710. As a result, cracks can be prevented from occurring. In some embodiments, the slitting portion 723 is formed to connect the first inclined portion 722 and the second inclined portion 724 of the first electrode tab 720 such that the edge region formed by the two inclined portions is not sharp. Accordingly, by further reducing the mechanical stress generated in a case where the end portion of the first electrode tab 720 comes into contact with the first electrode 710, cracks can be prevented from occurring.

Referring to FIG. 8, the slitting portion 723 may be chamfered to be rounded. In some embodiments, the slitting portion 723 may have a curved surface. However, the shape of the slitting portion 723 that is chamfered is not limited, and may include a single plane, a polygon, a circle, or a plane and/or a curved surface in a shape close to a circle. A method of chamfering the slitting portion 723 may include various manufacturing methods that can be used by a person skilled in the art to manufacture a flat surface and/or a curved surface of a plate-shaped or film-shaped material. In some embodiments, the various manufacturing methods may include a method of forming a first electrode tab 720 including metal or a conductor using a high-speed press, a cutting method using a laser, a grinding method, and the like. However, the present disclosure is not limited thereto.

The first inclined portion 722 and the second inclined portion 724 may be symmetrically formed. In some embodiments, a longitudinal direction of the first electrode tab 720 may be the first direction, and the second inclined portion 724 may be symmetric to the first inclined portion 722 with respect to a central axis of the first electrode tab 720 in the first direction. According to an embodiment, an angle formed by the second inclined portion 724 and the slitting portion 723 may be equal to an angle formed by the first inclined portion 722 and the slitting portion 723. In some embodiments, the first inclined portion 522 and the second inclined portion 524 may be asymmetrically formed, and the present disclosure is not limited thereto.

The first inclined portion 722 and the second inclined portion 724 may respectively form constant angles with the lower surface 726 and the upper surface 728 of the first electrode tab 720. According to an embodiment, the first inclined portion 722 and the second inclined portion 724 may respectively form obtuse angles relative to the lower surface 726 and the upper surface 728 of the first electrode tab 720. In some embodiments, the first inclined portion 722 and the second inclined portion 724 may respectively have angles of 100 to 150 degrees relative to the lower surface 726 and the upper surface 728 of the first electrode tab 720. According to an embodiment, the first inclined portion 722 and the second inclined portion 724 may respectively have angles of 120 to 170 degrees relative to the slitting portion 723.

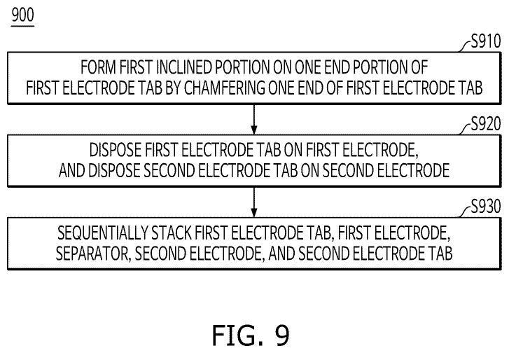

FIG. 9 is a flow chart showing a method 900 for manufacturing an electrode assembly according to an embodiment of the present disclosure.

Referring to FIG. 9, the method 900 for manufacturing the electrode assembly may be started when forming a first inclined portion at one end portion of the first electrode tab by chamfering one end portion of the first electrode tab (S910).

In some embodiments, the first inclined portion may have a thickness gradually decreasing towards one end of the first electrode tab, and the first inclined portion may have an angle of 100 to 150 degrees with respect to a lower surface of the first electrode tab.

In some embodiments, a second inclined portion may be formed to be symmetric to the first inclined portion by chamfering one end portion of the first electrode tab. In some embodiments, a slitting portion connecting the first inclined portion and the second inclined portion may be further formed.

In some embodiments, the first electrode tab may be disposed on the first electrode, and the second electrode tab may be disposed on the second electrode (S920). Here, the first electrode tab may be combined with the first electrode by being pressurized under a predetermined temperature condition.

In some embodiments, the first electrode tab, the first electrode, the separator, the second electrode, and the second electrode tab may be sequentially stacked (S930). The first electrode tab, the first electrode, the separator, the second electrode, and the second electrode tab may be sequentially stacked and mounted on the battery, or the stacked first electrode tab, the first electrode, the separator, the second electrode, and the second electrode tab may be wound and then mounted on the battery.

The flowchart of FIG. 9 and the description described above are merely examples of the present disclosure. The scope of the present disclosure is not limited to the flowchart of FIG. 9 and the description described above. In some embodiments, one or more steps in the flowchart and the description described above may be added, changed, and deleted, the order of one or more steps may be changed, and one or more steps may be performed simultaneously.

FIG. 10 shows a secondary battery 1000 including an electrode assembly according to an embodiment of the present disclosure. The secondary battery 1000 according to an embodiment of the present disclosure may include the electrode assembly according to the embodiment of the present disclosure.

The secondary battery 1000 according to the embodiment includes an electrode tab having a terminal shape formed diagonally according to the embodiment of the present disclosure. FIG. 10 shows the secondary battery 1000 as a cylindrical battery, but the scope of the present disclosure is not limited thereto. The secondary battery 1000 according to the embodiment of the present disclosure is not limited to a cylindrical battery, and may include batteries of any shape, such as a square battery, a pouch battery, and a coin battery. In some embodiments, the battery may be a type of the secondary battery.

The secondary battery 1000 may include an electrode assembly 40 with a separator 30 interposed between a positive electrode 10 and a negative electrode 20, a case 50 encompassing the electrode assembly 40, and a sealing member 60 that seals the case 50. The positive electrode 10, the negative electrode 20, and the separator 30 may be impregnated with an electrolyte (not shown).

In an embodiment, the positive electrode 10 and the negative electrode 20 may include a coated portion, which corresponds to a region where an active material is applied to a current collector (or substrate) including a thin metal foil, and a uncoated portion, which corresponds to a region where the active material is not coated. The separator 30, which is an insulator, may be interposed between the positive electrode 10 and the negative electrode 20, and then the positive electrode 10 and the negative electrode 20 may be wound. However, the present disclosure is not limited thereto. In some embodiments, the electrode assembly 40 may be formed with a structure in which the positive electrode 10 and the negative electrode 20 formed of a plurality of sheets are alternately stacked with the separator 30 interposed therebetween.

The electrode assembly 40 may be formed by winding or stacking a stacked body of the positive electrode 10, the separator 30, and the negative electrode 20 formed in a thin plate shape or a film shape. In some embodiments, the electrode assembly 40 is a rolled stacked body, and a winding axis may be parallel to a length direction of the case 50. In some embodiments, the electrode assembly 40 may be a stack type other than a rolled type, and the shape of the electrode assembly 40 is not limited in the present disclosure. In some embodiments, the electrode assembly 40 may be a Z-stack electrode assembly in which the positive electrode 10 and the negative electrode 20 are inserted on both sides of the separator folded into a Z-stack. In some embodiments, the electrode assembly 40 may be housed inside the case 50 by stacking one or more electrode assemblies 40 so that long sides thereof are adjacent to each other. The number of electrode assemblies 40 is not limited in the present disclosure.

The case 50 may include a material commonly used in the art to protect internal components of the battery from external impact or fire. In some embodiments, depending on the selection of a person skilled in the art in consideration of the purpose and function of the battery, the case 50 may be configured as a metal case, a plastic case, or a combination thereof. The metal case may include aluminum, an aluminum alloy, nickel-plated steel, or stainless steel. The plastic case may include GFRP. In some embodiments, the case 50 may form an overall appearance of the battery 1000 by providing a room in which the electrode assembly 40 is accommodated. In some embodiments, the battery 1000 is a cylindrical battery, the case 50 may have a cylindrical shape, and the positive electrode 10, the negative electrode 20, and the separator 30 may be wound to a cylindrical shape. In some embodiments, the electrode assembly 40 may be accommodated in the case 50 together with the electrolyte.

The electrode tabs, each of which has an inclined portion formed by chamfering one end portion, may be disposed to overlap at least partially at substantially the same position in the longitudinal direction of each of the positive electrode 10 and the negative electrode 20 (that is, the winding direction of the electrode assembly 40). In such a manner, the shape of the end portion of each of the electrode tabs of the positive electrode 10 and the negative electrode 20 of the electrode assembly 40 of the battery 1000 may be modified to be inclined obliquely in the width direction or the length direction of each electrode. Advantageously, mechanical stress generated in a case, where the terminal of the electrode tab presses the electrode substrate, can be reduced. The electrode tabs may be provided in one or more different locations as necessary, and the number of electrode tabs is not particularly limited.

In some embodiments, the electrode assembly 40 may be accommodated in the case 50 together with the electrolyte. In some embodiments, the electrode assembly 40 may be positioned so that the current collector is welded and connected to the electrode tabs 1010 of the positive electrode 10 and the negative electrode 20 exposed on both sides of the electrode assembly 40.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

What is claimed is:

1. An electrode assembly, comprising:
a first electrode;
a second electrode;
a separator disposed between the first electrode and the second electrode;
a first electrode tab disposed on the first electrode; and
a second electrode tab disposed on the second electrode,
wherein a first inclined portion formed at an end of the first electrode tab and a lower surface of the first electrode tab form an obtuse angle.

2. The electrode assembly as claimed in claim 1, wherein the first inclined portion has a thickness gradually decreasing towards the end of the first electrode tab.

3. The electrode assembly as claimed in claim 2, wherein the obtuse angle ranges from 100 to 150 degrees.

4. The electrode assembly as claimed in claim 1, wherein an end portion of the first inclined portion is separated from the first electrode.

5. The electrode assembly as claimed in claim 1,
wherein an end portion of the first inclined portion protrudes in a longitudinal direction equal to or less than 120 μm relative to an end of the lower surface of the first electrode tab.

6. The electrode assembly as claimed in claim 5, wherein the first inclined portion has a height substantially identical to the first electrode tab in a direction perpendicular to the longitudinal direction.

7. The electrode assembly as claimed in claim 1, wherein a second inclined portion is formed at the end of the first electrode tab, and wherein an end portion of the first inclined portion and an end portion of the second inclined portion form an interface.

8. The electrode assembly as claimed in claim 7,
wherein the second inclined portion is symmetric to the first inclined portion relative to a central axis of the first electrode tab in a longitudinal direction.

9. The electrode assembly as claimed in claim 7,
wherein the first inclined portion corresponds to the lower surface of the first electrode tab, and
wherein the second inclined portion corresponds to an upper surface of the first electrode tab.

10. The electrode assembly as claimed in claim 9, wherein the first inclined portion has an angle ranging from 100 to 150 degrees relative to the lower surface of the first electrode tab, and wherein the second inclined portion has an angle ranging from 100 to 150 degrees relative to the upper surface of the first electrode tab.

11. The electrode assembly as claimed in claim 7,
wherein the end portion of the first inclined portion and the end portion of the second inclined portion protrude in a longitudinal direction relative to either an end of the lower surface of the first electrode tab or an end of an upper surface of the first electrode tab.

12. The electrode assembly as claimed in claim 11, wherein a height of the first inclined portion in a direction perpendicular to the longitudinal direction is substantially equal to a height of the second inclined portion in the direction perpendicular to the longitudinal direction.

13. The electrode assembly as claimed in claim 7, wherein a slitting portion is formed at the end of the first electrode tab and is positioned between the first inclined portion and the second inclined portion such that an end portion of the first inclined portion and the slitting portion form a first interface and an end portion of the second inclined portion and the slitting portion form a second interface.

14. The electrode assembly as claimed in claim 13, wherein the slitting portion has a non-flat surface.

15. A secondary battery comprising an electrode assembly comprising:
a first electrode;
a second electrode;
a separator disposed between the first electrode and the second electrode;
a first electrode tab disposed on the first electrode; and
a second electrode tab disposed on the second electrode,
wherein a first inclined portion formed at an end of the first electrode tab and a lower surface of the first electrode tab form an obtuse angle.

16. A method for manufacturing an electrode assembly, comprising:
forming a first inclined portion at an end portion of a first electrode tab by chamfering the end portion of the first electrode tab;
disposing the first electrode tab on a first electrode of the electrode assembly and a second electrode tab on a second electrode of the electrode assembly; and
stacking the first electrode tab, the first electrode, a separator, the second electrode, and the second electrode tab.

17. The method as claimed in claim 16, wherein the first inclined portion has a thickness gradually decreasing towards the end of the first electrode tab, and wherein the first inclined portion and a lower surface of the surface of the first electrode tab has an angle ranging from 100 to 150 degrees.

18. The method as claimed in claim 17, wherein the forming comprises forming a second inclined portion at the end portion of the first electrode tab, symmetric to the first inclined portion, by chamfering the end portion of the first electrode tab.

19. The method as claimed in claim 18, wherein the forming further comprises forming a slitting portion at the end portion of the first electrode tab and positioned between the first inclined portion and the second inclined portion.

20. The method as claimed in claim 16, wherein the disposing comprises combining the first electrode tab with the first electrode.
